(19) United States
(12) Patent Application Publication
(10) Pub. No.: US 2013/0093855 A1
(43) Pub. Date: Apr. 18, 2013

(54) PARALLEL AXIS STEREOSCOPIC CAMERA

(71) Applicants: Hee Min Kang, Seongnam-si (KR); Eun Hwa Park, Yongin-si (KR)

(72) Inventors: Hee Min Kang, Seongnam-si (KR); Eun Hwa Park, Yongin-si (KR)

(73) Assignee: ASIC BANK CO., LTD., Gwangju-si, Gyeonggi-do (KR)

(21) Appl. No.: 13/641,275

(22) PCT Filed: Jul. 27, 2010
(86) PCT No.: PCT/KR2010/004916

§ 371 Date: Dec. 17, 2012

(30) Foreign Application Priority Data
Apr. 15, 2010 (KR) 10-2010-0034679

(51) Int. Cl. H04N 13/02

(52) U.S. Cl. CPC H04N 13/0239
USPC 348/47

(57) ABSTRACT

A parallel axis stereoscopic camera comprising: a camera unit which includes left and right image sensors each of which has a higher resolution than an output image, the camera unit outputting RGB data having the same resolution as the output image; a vergence controller which performs an electronic control for eliminating a binocular disparity of an object by changing a read-out starting point in the horizontal direction, of at least one of the left and right image sensors; an image processor including a left image processing unit which processes an image of left RGB data to output a left luminance/chrominance signal and a right image processing unit which processes an image of right RGB data to outputs a right luminance/chrominance signal under the control of the vergence controller; and a stereoscopic image synthesizer which synthesizes the left and right luminance/chrominance signals to produce a stereoscopic image.

### TECHNICAL FIELD

The present invention relates to a parallel axis stereoscopic camera. More particularly, the present invention relates to a parallel axis stereoscopic camera with vergence control function and electronic camera alignment function, which allows the parallel axis stereoscopic camera to electronically control the vergence, and which can minimize image loss generated due to the electronic vergence control error and the alignment error between a left hand side camera and a right hand side camera.

### BACKGROUND ART

In general, a stereoscopic camera obtains left and right images by using two cameras like human eyes, and allows an observer to feel stereoscopic effect by the parallax of the left and right images.

Parallax or binocular disparity refers to the difference in image direction of an object seen from two viewpoints, and allows the image of the object to be formed at different locations on image capturing surfaces of image sensors equipped in two cameras of a stereoscopic camera. Such a difference in image location is referred to as disparity amount, which provides an observer with distance information and thus allows the observer to feel stereoscopic effect.

People can observe an object with the eyes while comfortably feeling stereoscopic effect by moving left and right pupils such that the disparity amount of the object intended to observe becomes zero. The vergence control is meant by controlling the disparity amount as above, and when the disparity amount of an object to be observed is zero, people can view an image most comfortably.

In the case an observer views a stereoscopic image obtained from a camera not having the vergence control function, the disparity amount is so great that the observer feels seriously fatigued. To reduce such observation fatigue, the vergence control function for controlling the observational directions of the left and right cameras is essential such that a constant disparity is maintained regardless of a change in position of an object.

Meanwhile, stereoscopic cameras used for obtaining a stereoscopic image are classified into three types: a parallel-axis stereoscopic camera; a toed-in stereoscopic camera; and a horizontal shift-axis stereoscopic camera according to the arrangement ways of the left and right image sensors.

FIG. 1 is a view for conceptually explaining the operation principle of a conventional parallel axis stereoscopic camera.

Referring to FIG. 1, a parallel axis stereoscopic camera is the simplest one among the binocular stereoscopic cameras, and is designed to obtain an image with two image sensors spaced apart in parallel by a distance which is almost equal to an interval between human eyes and fixed. However, since the parallel axis stereoscopic camera does not have the vergence control function, it has a problem in that the disparity amount cannot be adjusted according to a change in distance from an object.

FIG. 2 is a view for conceptually explaining the operation principle of a conventional toed-in stereoscopic camera.

Referring to FIG. 2, a conventional toed-in stereoscopic camera is designed to perform vergence control according to a change in distance from an object. This toed-in stereoscopic camera controls the vergence such that an image of the object is always formed at the center of left and right image sensors by rotating the optical axis of the image sensors according to the change in distance from the object. This operation is imitated from the motion of human pupil, i.e., when people see a near object, the pupil is contracted inwardly, whereas when people see a far object, the pupil is wide open.

However, in the case of the toed-in type, since the vergence is adjusted by crossing the image sensors, the change in interval between the image sensors is so much that serious distortion is generated in reproduction of a stereoscopic image. Also, since the vergence control has to be performed by rotation of the optical axis of the camera, the toed-in stereoscopic camera has a difficulty in miniaturization.

FIG. 3 is a view for conceptually explaining the operation principle of a conventional horizontal moving axis stereoscopic camera.

Referring to FIG. 3, a horizontal moving axis stereoscopic camera is a camera capable of performing vergence control according to the change in distance from an observation object like the toed-in stereoscopic camera. However, unlike the toed-in stereoscopic camera, the horizontal moving axis stereoscopic camera is designed to control the vergence by allowing the image sensors to horizontally move in parallel with respect to lenses separated from the respective image sensors. According to the type of controlling the vergence by parallel movement of the image sensors, the horizontal moving axis stereoscopic camera has an advantage in that it has a less image distortion than the toed-in stereoscopic camera since a change in interval between two image sensors is small, but since the lenses are separated from the image sensors and the vergence control is performed while moving the image sensors, the horizontal moving axis stereoscopic camera has a drawback in that it is difficult to actually manufacture the horizontal moving axis stereoscopic camera.

As described previously in brief, the parallel axis stereoscopic camera has a great advantage in that although it does not have the mechanical vergence control function, it is structurally simple, unlike the toed-in stereoscopic camera or the horizontal moving axis stereoscopic camera. To utilize the advantage of the parallel axis stereoscopic camera, the way of electronically controlling the vergence via a signal processing using software is used.

However, the conventional parallel axis stereoscopic camera has a drawback in that image loss due to an error of mechanical alignment and image loss in the course of the vergence control are generated.

Such drawbacks will be described in more detail with reference to FIGS. 4 and 5.

FIG. 4 is a view for explaining image loss generated due to the mechanical alignment error between a left camera and a right camera constituting a conventional parallel axis stereoscopic camera.

Referring to FIG. 4, a horizontal error and a vertical error are generated due to the mechanical alignment error between a left camera and a right camera. For example, in the case the resolution of each of left image sensor and right image sensor is 921,600 pixels (=1,280×720), the horizontal error is 100 pixels, and the vertical error is 50 pixels, image loss of 131,000 pixels (=100×720+50×(1280−100)) is generated. As a result, the resolution of a desired output image is 921,600 pixels (=1,280×720), but the image loss of 131,000 pixels is generated due to the mechanical alignment error, and thus the resolution of an actual output image becomes 790,600 pixels (=1180×670).

FIG. 5 is a view for explaining image loss generated in the course of vergence control which is required by a conventional parallel axis stereoscopic camera.

Referring to FIG. 5, a way of combining left and right images with parallax and controlling vergence by software is conceptually illustrated. However, in this approach, since images A and B of total fields are taken as they are and used, or images photographed in advance are edited and used, it is possible to control vergence, but non-overlapping regions (2Ds) of two images may be generated. Therefore, as illustrated in FIG. 5, it is problematic that some of left and right images or some of upper and lower images are not realized.

Also, the approach of compensating for image loss generated in and in the course of the conventional vergence control by using an interpolation method or the like is disclosed in Korean Patent Laid Open Publication Nos. 10-2007-0021694, 10-2007-0030501, 10-2002-0037097, and 10-2004-005252.

However, since in those approaches, a stereoscopic image is generated by using two general cameras manufactured in advance, an external memory should be basically provided so as to perform the vergence control. That is, in those approaches, the vergence control is performed by temporarily storing left/right image in the external memory and then differently adjusting read out timings of the external memory for parallax of the left and right images. The image loss generated due to the alignment error of the left and right cameras is compensated for by a method such as interpolation or the like using data stored in the external memory. As seen from the above description, according to the conventional approaches, an additional external memory is required, and distortion of an image and delay of an image by one frame or more are generated in the vergence control and in the course of compensating for lost image.

### DISCLOSURE OF THE INVENTION

### Technical Problem

A technical object of the present invention is to provide a parallel axis stereoscopic camera with electronic vergence control function and electronic camera alignment function that can prevent image loss due to the mechanical alignment error between left and right cameras.

Another technical object of the present invention is to provide a parallel axis stereoscopic camera with electronic vergence control function and electronic camera alignment function that can prevent image loss in the course of vergence control.

A further technical object of the present invention is to provide a parallel axis stereoscopic camera with electronic vergence control function and electronic camera alignment function that can minimize image distortion and time delay in the course of generating a stereoscopic image by simplifying a signal processing procedure for vergence control.

A further another technical object of the present invention is to provide a parallel axis stereoscopic camera with electronic vergence control function and electronic camera alignment function that can reduce manufacturing costs by decreasing the number of elements such as an external memory and the like required in the course of vergence control.

### Technical Solution

To accomplish these objects, according to an aspect of the present invention, a parallel axis stereoscopic camera comprises: a camera unit which includes a left image sensor and a right image sensor each of which has a higher resolution than an output image, the camera unit outputting RGB data having the same resolution as the output image; a vergence controller which performs an electronic control for eliminating a binocular disparity of an object by changing a read-out starting point in the horizontal direction, of at least one of the left and right image sensors; an image processor including a left image processing unit which processes an image of left RGB data to output a left luminance/chrominance signal and a right image processing unit which processes an image of right RGB data to outputs a right luminance/chrominance signal under the control of the vergence controller; and a stereoscopic image synthesizer which synthesizes the left luminance/chrominance signal and the right luminance/chrominance signal to produce a stereoscopic image.

According to another aspect of the present invention, a parallel axis stereoscopic camera comprises: a camera unit which includes a left image sensor and a right image sensor each of which has a higher resolution than an output image, the camera unit outputting RGB data having the same resolution as the output image; a vergence controller which performs an electronic control for eliminating a binocular disparity of an object by changing a read-out starting point in the horizontal direction, of at least one of the left and right image sensors; a stereoscopic RGB data synthesizer which synthesizes left RGB data outputted from the left image sensor with right RGF data outputted from the right image sensor to produce stereoscopic RGB data under the control of the vergence controller; and an image processor which processes an image of the stereoscopic RGB data to output a stereoscopic image comprised of a left luminance/chrominance signal and a right luminance/chrominance signal.

According to a further aspect of the present invention, a parallel axis stereoscopic camera comprises: a camera unit which includes a left image sensor and a right image sensor each of which has a higher resolution than an output image, the camera unit outputting RGB data having the same resolution as the output image; a vergence controller which performs an electronic control for eliminating a binocular disparity of an object by changing a read-out starting point in the horizontal direction, of at least one of the left and right image sensors; a stereoscopic image processor which processes an image of left RGB data outputted from the left image sensor to generate a left luminance/chrominance signal, processes an image of right RGB data outputted from the right image sensor to generate a right luminance/chrominance signal, and corrects and outputs the left luminance/chrominance signal and the right luminance/chrominance signal such that differences in luminance and color between the left luminance/chrominance signal and the right luminance/chrominance signal under the control of the vergence controller; and a stereoscopic image synthesizer which synthesizes the left luminance/chrominance signal and the right luminance/chrominance signal inputted from the stereoscopic image processor to produce a stereoscopic image.

According to still another aspect of the present invention, a parallel axis stereoscopic camera comprises: a camera unit which includes a left image sensor and a right image sensor each of which has a higher resolution than an output image, the camera unit outputting left luminance/chrominance signal and right luminance/chrominance signal having the same resolution as the output image; a vergence controller which performs an electronic control for eliminating a binocular disparity of an object by changing a read-out starting point in the horizontal direction, of at least one of the left and right image sensors; and a stereoscopic image synthesizer which synthesizes the left luminance/chrominance signal and the right luminance/chrominance signal to produce a stereoscopic image.

Various aspects of the present invention are characterized in that initial read-out starting points of the left image sensor and the right image sensor, and the resolution of the output image are preset such that there is no image loss of the output image.

Various aspects of the present invention are characterized in the initial read-out starting points of the left image sensor and the right image sensor, and the resolution of the output image are changeable.

Various aspects of the present invention are characterized in that the vergence controller calculates the binocular disparity between the left luminance/chrominance signal and the right luminance/chrominance signal, and changes the read-out starting point of at least one of the left image sensor and the right image sensor such that the binocular disparity between the left luminance/chrominance signal and the right luminance/chrominance signal is eliminated.

Various aspects of the present invention are characterized in that the vergence controller calculates the binocular disparity with respect to a middle object located in the middle among the objects.

Various aspects of the present invention are characterized in that the left image sensor and the right image sensor are mounted spaced apart from each other on a printed circuit board, and at least one of the vergence controller, the image processor, the stereoscopic image synthesizer, the stereoscopic RGB data synthesizer, and the stereoscopic image processor is mounted on the printed circuit board between the left image sensor and the right image sensor.

Various aspects of the present invention are characterized in that the left image sensor and the right image sensor are mounted spaced apart from each other on a wafer, and at least one of the vergence controller, the image processor, the stereoscopic image synthesizer, the stereoscopic RGB data synthesizer, and the stereoscopic image processor is mounted on the wafer between the left image sensor and the right image sensor.

### ADVANTAGEOUS EFFECTS

According to the present invention, there is an effect to provide a parallel axis stereoscopic camera with electronic vergence control function and electronic camera alignment function that can prevent image loss due to the mechanical alignment error between left and right cameras.

Also, there is an effect to provide a parallel axis stereoscopic camera with electronic vergence control function and electronic camera alignment function that can prevent image loss in the course of vergence control.

Further, there is an effect to provide a parallel axis stereoscopic camera with electronic vergence control function and electronic camera alignment function that can minimize image distortion and time delay in the course of generating a stereoscopic image by simplifying a signal processing procedure for vergence control.

Moreover, there is an effect to provide a parallel axis stereoscopic camera with electronic vergence control function and electronic camera alignment function that can reduce manufacturing costs by decreasing the number of elements such as an external memory and the like required in the course of vergence control.

### BRIEF DESCRIPTION OF THE DRAWINGS

FIG. 1 is a view for conceptually explaining the operation principle of a conventional parallel axis stereoscopic camera.

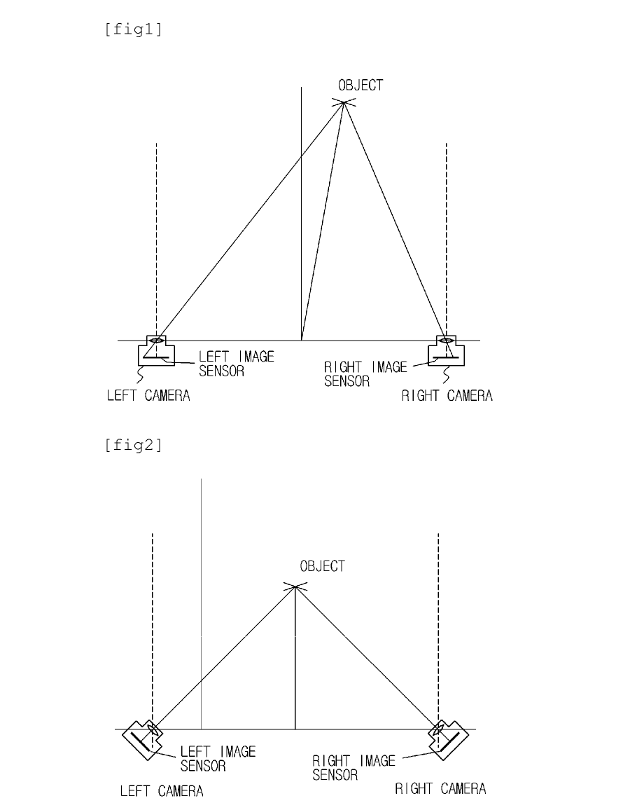

FIG. 2 is a view for conceptually explaining the operation principle of a conventional toed-in stereoscopic camera.

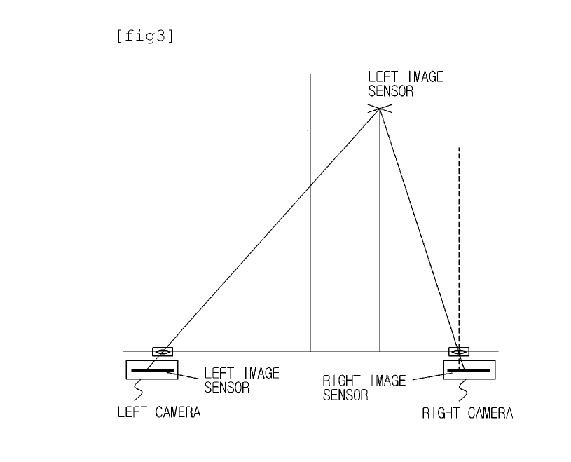

FIG. 3 is a view for conceptually explaining the operation principle of a conventional horizontal moving axis stereoscopic camera.

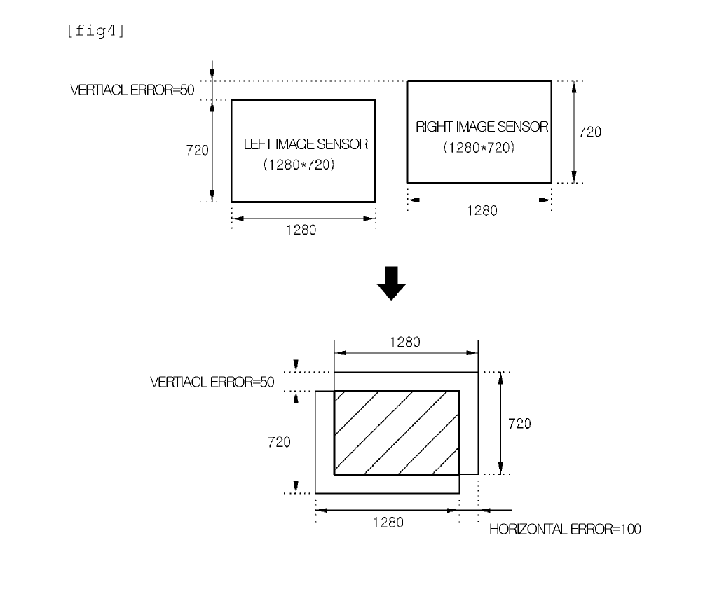

FIG. 4 is a view for explaining image loss generated due to the mechanical alignment error between a left camera and a right camera constituting a conventional parallel axis stereoscopic camera.

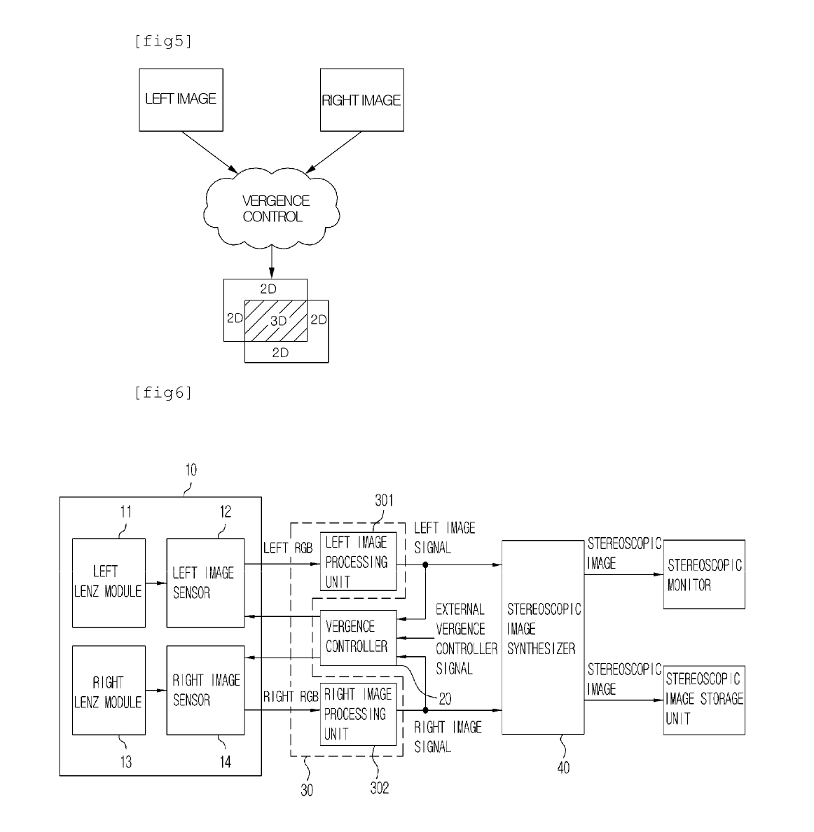

FIG. 5 is a view for explaining image loss generated in the course of vergence control which is required by a conventional parallel axis stereoscopic camera.

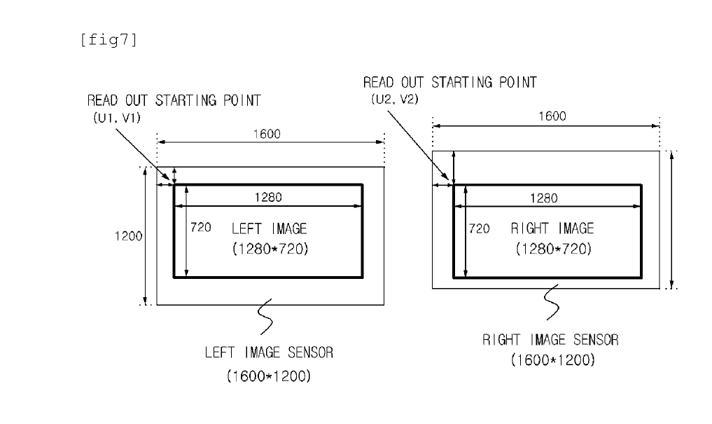

FIG. 6 is a block diagram of a parallel axis stereoscopic camera according to a first embodiment of the present invention.

FIG. 7 is a view for explaining the principle to prevent loss of an output image due to an alignment error between a left image sensor and a right image sensor by using the left and right image sensor having a higher resolution than the resolution of a final output image in the first embodiment of the present invention.

FIG. 8 is a view for explaining the principle to prevent loss of an output image in the course of vergence control by using the left and right image sensors having a higher resolution than the resolution of a final output image in the first embodiment of the present invention.

FIGS. 9 to 11 are views for concretely explaining a method of controlling a vergence in the first embodiment of the present invention.

FIG. 12 is a block diagram of a parallel axis stereoscopic camera according to a second embodiment of the present invention.

FIG. 13 is a block diagram of a parallel axis stereoscopic camera according to a third embodiment of the present invention.

FIG. 14 is a block diagram of a parallel axis stereoscopic camera according to a fourth embodiment of the present invention.

### DESCRIPTION OF THE SYMBOLS IN MAIN PORTIONS OF THE DRAWINGS

10: Camera unit

11: Left lens module

12: Left image sensor

13: Right lens module

14: Right image sensor

20: Vergence controller

30, 32, 33: Image processor

40, 43, 44: Stereoscopic image synthesizer

42: Stereoscopic RGB data synthesizer

301: Left image processing unit

302: Right image processing unit

### BEST MODE

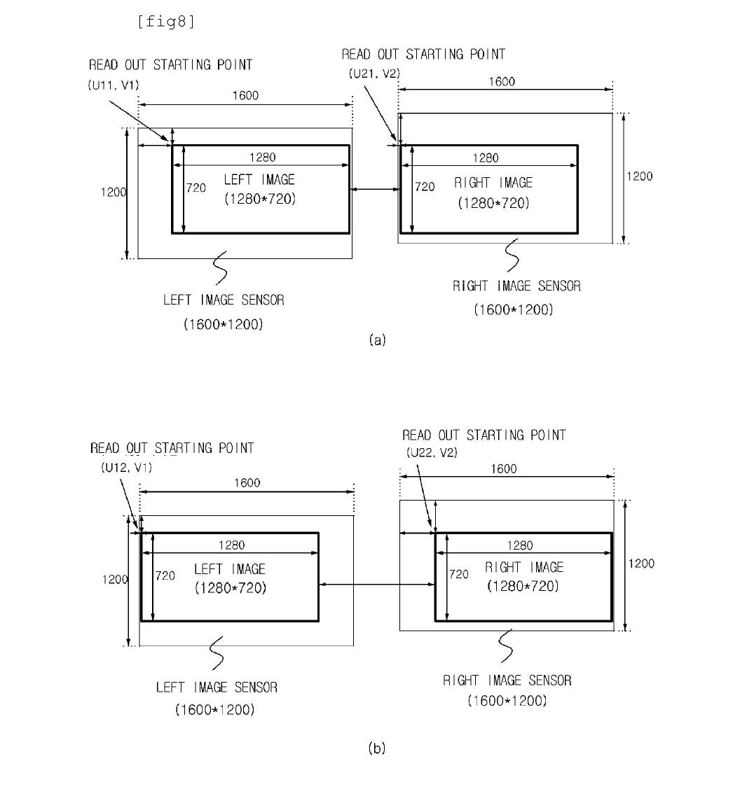

FIG. 6 is a block diagram of a parallel axis stereoscopic camera according to a first embodiment of the present invention.

Referring to FIG. 6, a parallel axis stereoscopic camera according to a first embodiment of the present invention includes a camera unit 10, a vergence controller 20, an image processor 30, and a stereoscopic image synthesizer 40.

The camera unit 10 includes a left lens module 11, a left image sensor 12, a right lens module 13, and a right image sensor 14, and the resolution of each of the left image sensor 12 and the right image sensor 14 is higher than that of a stereoscopic image that is a final output image.

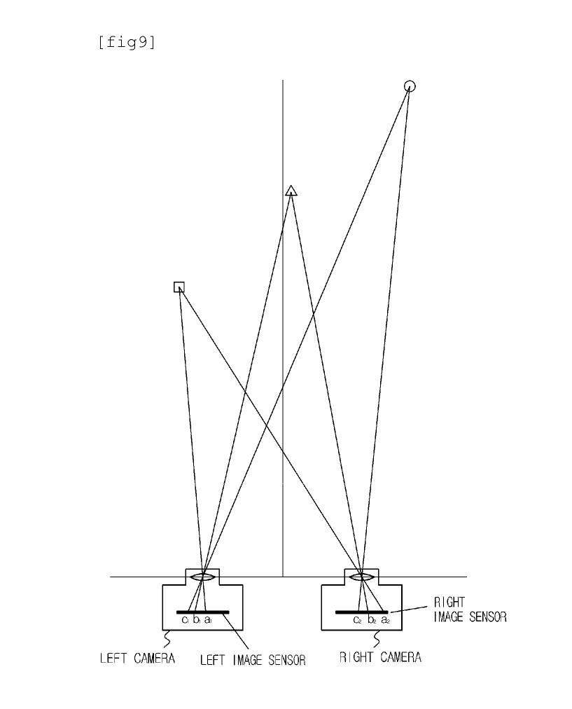

The reason the left image sensor 12 and the right image sensor 14 are designed with the high resolution, i.e., large size will be described with reference to FIG. 7.

FIG. 7 is a view for explaining the principle to prevent loss of an output image due to an alignment error between the left image sensor 12 and the right image sensor 14 by using the left and right image sensor 12 and 14 having a higher resolution than the resolution of a final output image in the first embodiment of the present invention.

Referring to FIG. 7, in the case the output image wants the resolution of 1280×720, each of the two image sensors 12 and 14 is designed with the resolution of 1600×1200.

Thus, by selecting image sensors having the resolution which is higher than the resolution necessary for the output image so as to eliminate image loss generated due to an alignment error between the left camera and the right camera, and setting a data read-out starting point of the left image sensor 12, a data read-out starting point of the left image sensor 12, and the resolution of the output image such that a left/right common portion of data of the left and right image sensors 12 and 14 is windowed by a desired size of output image, since a desired size of image is always outputted, image loss is not generated.

It is preferable that an initial read-out starting point U1, V1 of the left image sensor 12, an initial read-out starting point U2, V2 of the right image sensor 14, and the resolution (1,280×720) of the output image set in advance in the course of manufacturing a stereoscopic camera such that there is no image loss of the output image. The resolution of the output image may be set in a way to input a terminating point reading out data of the image sensor. For concrete example, when manufacturing a parallel axis stereoscopic camera for the first time, a manufacturer may manufacture the parallel axis stereoscopic camera in such a way to input the initial read-out starting point U1, V1 and the initial read-out starting point U2, V2 of the right image sensor 14 into the left image sensor 12 and the right image sensor 14 by using an external vergence control signal of the vergence controller 20 with observing left image and right image of the parallel axis stereoscopic camera via a 2D monitor.

In short, in spite of mechanical alignment error, the camera unit 10 outputs RGB data having the same resolution as a necessary output image without image loss, i.e., overall RGB data which is required for generate a stereoscopic image which is finally outputted.

Meanwhile, it is preferable that the initial read-out starting point of the left image sensor 12, the initial read-out starting point of the right image sensor 14, and the resolution of the output image be designed such that they may be changed by a user if necessary.

The vergence controller 20 is means to perform electronic control for eliminating binocular disparity of an object by changing the read-out starting point in the horizontal direction, of at least one of the left image sensor 12 and the right image sensor 14.

For example, the vergence controller 20 may be designed such that it calculates the binocular disparity between a left luminance/chrominance signal that is an image signal outputted by a left image processor 301 and a right luminance/chrominance signal that is an image signal outputted by a right image processor 302, and then changes the read-out starting point of at least one of the left image sensor 12 and the right image sensor 14 to eliminate the calculated binocular disparity between the left luminance/chrominance signal and the right luminance/chrominance signal.

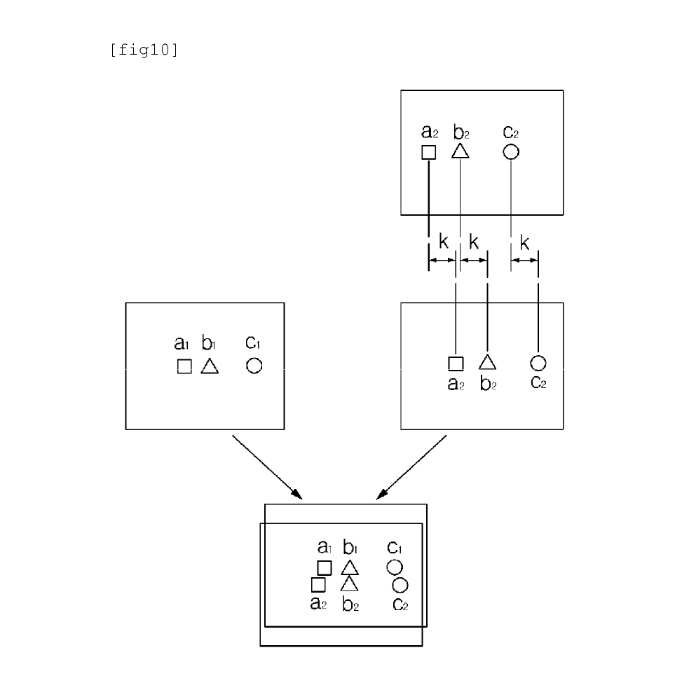

This operation will be described with reference to FIG. 8.

FIG. 8 is a view for explaining the principle to prevent loss of an output image in the course of vergence control by using the left and right image sensors 12 and 14 having a higher resolution than the resolution of a final output image in the first embodiment of the present invention.

Referring to FIG. 8, the vergence control is performed by changing the read-out starting points in the horizontal direction, of the left image sensor 12 and the right image sensor 14 according to an internal or external vergence control signal (which eliminates the binocular disparity of an object, corresponds to a position where the binocular disparity of the object becomes zero, and which may be changed automatically or manually according to the object). FIG. 8a shows the vergence control when an object is positioned near, and FIG. 8b shows the vergence control when an object is positioned far. It can be understood that image loss is not generated in any case.

According to the above vergence control method, since the vergence control can be performed without image loss by changing only the starting point of the image sensor, there is no need of additional external memory or the like, and problems such as image distortion, time delay, and the like are not generated, unlike the conventional vergence control method,

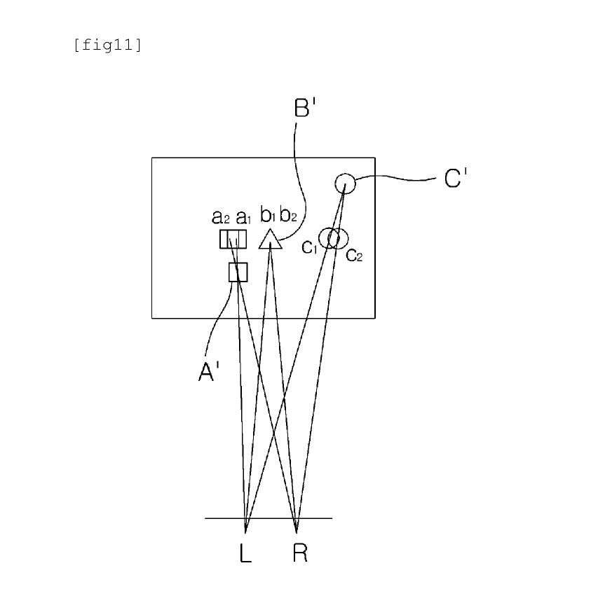

FIGS. 9 to 11 are views for concretely explaining a method of controlling a vergence in the first embodiment of the present invention.

Referring to FIGS. 9 to 11, for the vergence control of three objects, the vergence controller 20 receives left image signals for the three objects from the left image processor 301, and right image signals for the right image processor 302.

In this case, the vergence controller 20 calculates the binocular disparity of middle objects b1 and b2, i.e., a spacing (k) between b1 and b2, and then moves the image of the left camera to the left so as to eliminate the binocular disparity of middle objects b1 and b2.

That is, the vergence controller 20 moves the right image to the left by inputting a data read-out position to the right image sensor 14 by a distance intended to move the image of the right camera to the left. By processing as above, as shown in FIG. 11, point B′ with zero of binocular disparity is expressed on a stereoscopic monitor, point A′ positioned in front of point B′ is seen nearer than the plane of the stereoscopic monitor, and point C′ positioned behind point B′ is seen further than the plane of the stereoscopic monitor, so that natural stereoscopic feeling is generated.

This automatic vergence control function of the vergence controller 20 is automatically performed whenever the object is changed, to thereby allow a natural stereoscopic image to be obtained, and the vergence control range may be maximized by adjusting the read-out points of the left and right image sensors 12 and 14 together.

The image processor 30 includes the left image processing unit 301 and the right image processing unit 302, and the left image processing unit 301 processes an image of left RGF data outputted from the left image sensor 12 to output a left luminance/chrominance signal, and the right image processing unit 302 processes an image of right RGF data outputted from the right image sensor 14 to output a right luminance/chrominance signal under the control of the vergence controller 20.

The stereoscopic image synthesizer 40 synthesizes the left luminance/chrominance signal and the right luminance/chrominance signal to produce and output a stereoscopic image.

The first embodiment of the present invention may further include a stereoscopic monitor outputting the stereoscopic image produced by the stereoscopic image synthesizer 40, and a storage unit for storing the stereoscopic image.

Meanwhile, the parallel axis stereoscopic camera may be designed such that the left image sensor 12 and the right image sensor 14 are mounted spaced apart from each other on a printed circuit and at least one of the vergence controller 20, the image processor 30, and the stereoscopic image synthesizer 40 is mounted on the printed circuit board between the left image sensor 12 and the right image sensor 14. Alternatively, the parallel axis stereoscopic camera may be designed such that the left image sensor 12 and the right image sensor 14 are mounted spaced apart from each other on a wafer and at least one of the vergence controller 20, the image processor 30, and the stereoscopic image synthesizer 40 is mounted on the wafer between the left image sensor 12 and the right image sensor 14. According to the above constructions, the size of the stereoscopic camera can be reduced, and thus there is an effect to provide a parallel axis stereoscopic camera built in a device such as a handheld terminal.

As described in detail, according to the present invention, there is an effect to provide a parallel axis stereoscopic camera with electronic vergence control function and electronic camera alignment function that can prevent image loss due to the mechanical alignment error between left and right cameras.

Also, there is an effect to provide a parallel axis stereoscopic camera with electronic vergence control function and electronic camera alignment function that can prevent image loss in the course of vergence control.

Further, there is an effect to provide a parallel axis stereoscopic camera with electronic vergence control function and electronic camera alignment function that can minimize image distortion and time delay in the course of generating a stereoscopic image by simplifying a signal processing procedure for vergence control.

Moreover, there is an effect to provide a parallel axis stereoscopic camera with electronic vergence control function and electronic camera alignment function that can reduce manufacturing costs by decreasing the number of elements such as an external memory and the like required in the course of vergence control.

Also, since the size of the stereoscopic camera can be reduced, there is an effect to provide a parallel axis stereoscopic camera which can be built in a device such as a handheld terminal and has the electronic vergence control function and the electronic camera alignment function.

### MODE FOR CARRYING OUT THE INVENTION

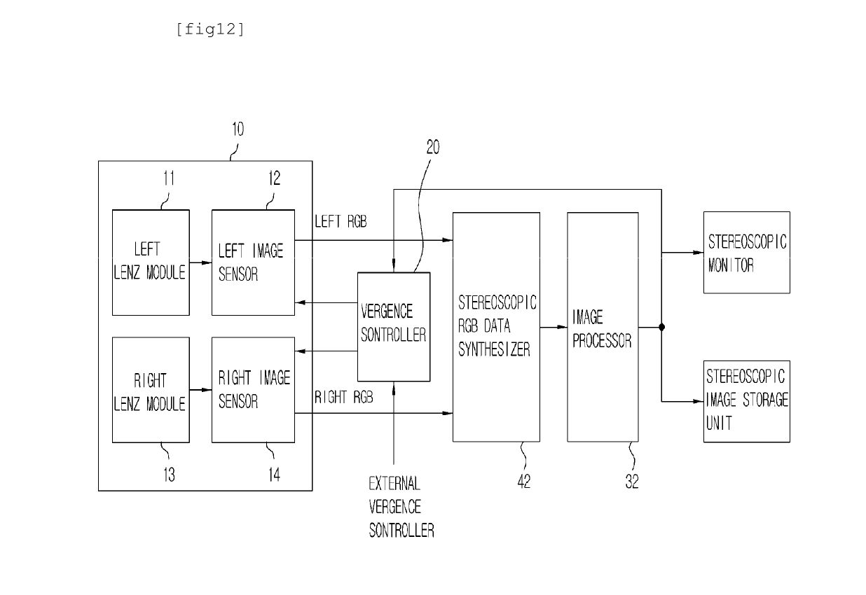

FIG. 12 is a block diagram of a parallel axis stereoscopic camera according to a second embodiment of the present invention.

Referring to FIG. 12, a parallel axis stereoscopic camera according to a second embodiment of the present invention includes: a camera unit 10 which includes a left image sensor 12 and a right image sensor 14 each of which has a higher resolution than an output image, the camera unit outputting RGB data having the same resolution as the output image; a vergence controller 20 which performs an electronic control for eliminating a binocular disparity of an object by changing a read-out starting point in the horizontal direction, of at least one of the left and right image sensors 12 and 14; a stereoscopic RGB data synthesizer 42 which synthesizes left RGB data outputted from the left image sensor 12 with right RGF data outputted from the right image sensor 14 to produce stereoscopic RGB data under the control of the vergence controller 20; and an image processor 32 which processes an image of the stereoscopic RGB data to output a stereoscopic image comprised of a left luminance/chrominance signal and a right luminance/chrominance signal.

The function of the vergence controller 20 included in the second embodiment is the same as that of the vergence controller 20 included in the first embodiment.

Compared with the first embodiment, the second embodiment has the following characteristics.

That is, the stereoscopic RGB data synthesizer 42 receives outputs (i.e., left RGB data and right RGB data each having the resolution of 1280×720) of two image sensors 12 and 14 to synthesize the two received data to one stereoscopic RGB data (2560×720, Full Frame Side by Side). This stereoscopic RGB data is processed in the single image processor 32. Thus, left and right images can be expressed more naturally.

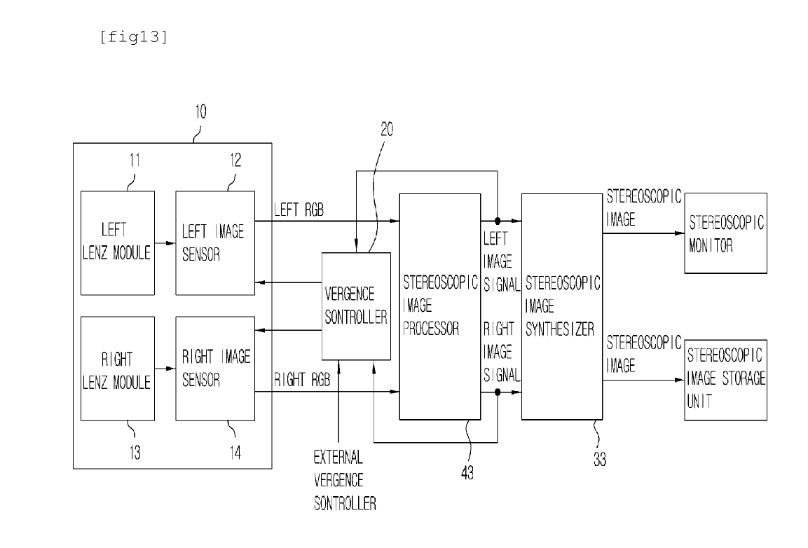

FIG. 13 is a block diagram of a parallel axis stereoscopic camera according to a third embodiment of the present invention.

Referring to FIG. 13, a parallel axis stereoscopic camera according to a third embodiment of the present invention includes: a camera unit 10 which includes a left image sensor 12 and a right image sensor 14 each of which has a higher resolution than an output image, the camera unit outputting RGB data having the same resolution as the output image; a vergence controller 20 which performs an electronic control for eliminating a binocular disparity of an object by changing a read-out starting point in the horizontal direction, of at least one of the left and right image sensors 12 and 14; a stereoscopic image processor 33 which processes an image of left RGB data outputted from the left image sensor 12 to generate a left luminance/chrominance signal, processes an image of right RGB data outputted from the right image sensor 14 to generate a right luminance/chrominance signal, and corrects and outputs the left luminance/chrominance signal and the right luminance/chrominance signal such that differences in luminance and color between the left luminance/chrominance signal and the right luminance/chrominance signal under the control of the vergence controller 20; and a stereoscopic image synthesizer 43 which synthesizes the left luminance/chrominance signal and the right luminance/chrominance signal inputted from the stereoscopic image processor 33 to produce a stereoscopic image.

A single difference between the second embodiment and the third embodiment is the sequence of the image signal processing and the stereoscopic image synthesizing.

A difference between the second embodiment and the third embodiment is the function of the stereoscopic image processor 33. More concretely, under the control of the vergence controller 20, the stereoscopic image processor 33 processes an image of left RGB data outputted from the left image sensor 12 to generate a left luminance/chrominance signal, processes an image of right RGB data outputted from the right image sensor 14 to generate a right luminance/chrominance signal, corrects the left luminance/chrominance signal and the right luminance/chrominance signal such that differences in luminance and color between the left luminance/chrominance signal and the right luminance/chrominance signal, and outputs the corrected signals to the stereoscopic image synthesizer 43.

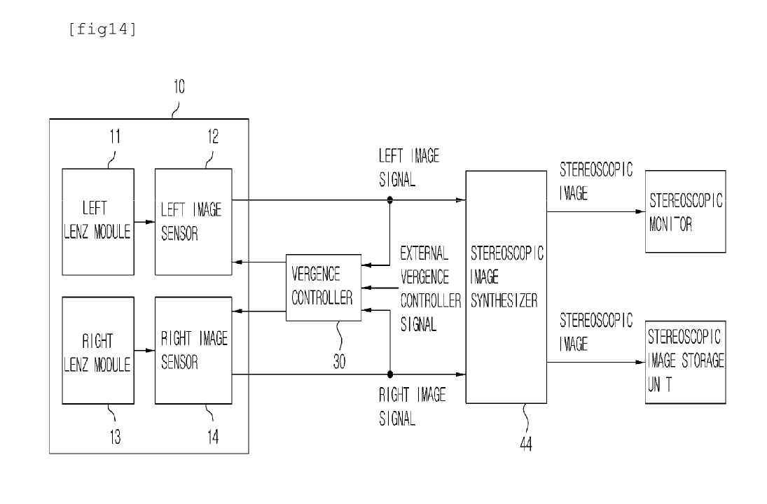

FIG. 14 is a block diagram of a parallel axis stereoscopic camera according to a fourth embodiment of the present invention.

Referring to FIG. 14, a parallel axis stereoscopic camera according to a fourth embodiment of the present invention includes: a camera unit 10 which includes a left image sensor 12 and a right image sensor 14 each of which has a higher resolution than an output image, the camera unit 10 outputting left luminance/chrominance signal and right luminance/chrominance signal having the same resolution as the output image; a vergence controller 20 which performs an electronic control for eliminating a binocular disparity of an object by changing a read-out starting point in the horizontal direction, of at least one of the left and right image sensors 12 and 14; and a stereoscopic image synthesizer 44 which synthesizes the left luminance/chrominance signal and the right luminance/chrominance signal to produce a stereoscopic image.

Compared with other embodiments, the fourth embodiment is characterized in that the block performing the image signal processing function is included in the left and right image sensors 12 and 14.

Although the technical ideas of the present invention have been described with reference to the accompanying drawings, they should not be construed as limiting the present invention; rather they are provided for exemplarily describing preferred embodiments of the present invention. It will be apparent to those skilled in the art that various modifications and variations can be made in the present invention without departing form the scope of the technical ideas of the invention.

1. A parallel axis stereoscopic camera comprising:
a camera unit which includes a left image sensor and a right image sensor each of which has a higher resolution than an output image, the camera unit outputting RGB data having the same resolution as the output image;
a vergence controller which performs an electronic control for eliminating a binocular disparity of an object by changing a read-out starting point in the horizontal direction, of at least one of the left and right image sensors;
an image processor including a left image processing unit which processes an image of left RGB data to output a left luminance/chrominance signal and a right image processing unit which processes an image of right RGB data to outputs a right luminance/chrominance signal under the control of the vergence controller; and
a stereoscopic image synthesizer which synthesizes the left luminance/chrominance signal and the right luminance/chrominance signal to produce a stereoscopic image.

2. A parallel axis stereoscopic camera comprising:
a camera unit which includes a left image sensor and a right image sensor each of which has a higher resolution than an output image, the camera unit outputting RGB data having the same resolution as the output image;
a vergence controller which performs an electronic control for eliminating a binocular disparity of an object by changing a read-out starting point in the horizontal direction, of at least one of the left and right image sensors;
a stereoscopic RGB data synthesizer which synthesizes left RGB data outputted from the left image sensor with right RGF data outputted from the right image sensor to produce stereoscopic RGB data under the control of the vergence controller; and
an image processor which processes an image of the stereoscopic RGB data to output a stereoscopic image comprised of a left luminance/chrominance signal and a right luminance/chrominance signal.

3. A parallel axis stereoscopic camera comprising:
a camera unit which includes a left image sensor and a right image sensor each of which has a higher resolution than an output image, the camera unit outputting RGB data having the same resolution as the output image;
a vergence controller which performs an electronic control for eliminating a binocular disparity of an object by changing a read-out starting point in the horizontal direction, of at least one of the left and right image sensors;
a stereoscopic image processor which processes an image of left RGB data outputted from the left image sensor to generate a left luminance/chrominance signal, processes an image of right RGB data outputted from the right image sensor to generate a right luminance/chrominance signal, and corrects and outputs the left luminance/chrominance signal and the right luminance/chrominance signal such that differences in luminance and color between the left luminance/chrominance signal and the right luminance/chrominance signal under the control of the vergence controller; and
a stereoscopic image synthesizer which synthesizes the left luminance/chrominance signal and the right luminance/chrominance signal inputted from the stereoscopic image processor to produce a stereoscopic image.

4. The parallel axis stereoscopic camera of claim 1, wherein initial read-out starting points of the left image sensor and the right image sensor, and the resolution of the output image are preset such that there is no image loss of the output image.

5. The parallel axis stereoscopic camera of claim 4, wherein the initial read-out starting points of the left image sensor and the right image sensor, and the resolution of the output image are changeable.

6. The parallel axis stereoscopic camera of claim 1, wherein the vergence controller calculates the binocular disparity between the left luminance/chrominance signal and the right luminance/chrominance signal, and changes the read-out starting point of at least one of the left image sensor and the right image sensor such that the binocular disparity between the left luminance/chrominance signal and the right luminance/chrominance signal is eliminated.

7. The parallel axis stereoscopic camera of claim 6, wherein the vergence controller calculates the binocular disparity with respect to a middle object located in the middle among the objects.

8. The parallel axis stereoscopic camera of claim 1, wherein the left image sensor and the right image sensor are mounted spaced apart from each other on a printed circuit board, and at least one of the vergence controller, the image processor, the stereoscopic image synthesizer, the stereoscopic RGB data synthesizer, and the stereoscopic image processor is mounted on the printed circuit board between the left image sensor and the right image sensor.

9. The parallel axis stereoscopic camera of claim 1, wherein the left image sensor and the right image sensor are mounted spaced apart from each other on a wafer, and at least one of the vergence controller, the image processor, the stereoscopic image synthesizer, the stereoscopic RGB data synthesizer, and the stereoscopic image processor is mounted on the wafer between the left image sensor and the right image sensor.

10. The parallel axis stereoscopic camera of claim 2, wherein initial read-out starting points of the left image sensor and the right image sensor, and the resolution of the output image are preset such that there is no image loss of the output image.

11. The parallel axis stereoscopic camera of claim 3, wherein initial read-out starting points of the left image sensor and the right image sensor, and the resolution of the output image are preset such that there is no image loss of the output image.

12. The parallel axis stereoscopic camera of claim 10, wherein the initial read-out starting points of the left image sensor and the right image sensor, and the resolution of the output image are changeable.

13. The parallel axis stereoscopic camera of claim 11, wherein the initial read-out starting points of the left image sensor and the right image sensor, and the resolution of the output image are changeable.

14. The parallel axis stereoscopic camera of claim 2, wherein the vergence controller calculates the binocular disparity between the left luminance/chrominance signal and the right luminance/chrominance signal, and changes the read-out starting point of at least one of the left image sensor and the right image sensor such that the binocular disparity between the left luminance/chrominance signal and the right luminance/chrominance signal is eliminated.

15. The parallel axis stereoscopic camera of claim 3, wherein the vergence controller calculates the binocular disparity between the left luminance/chrominance signal and the right luminance/chrominance signal, and changes the read-out starting point of at least one of the left image sensor and the right image sensor such that the binocular disparity between the left luminance/chrominance signal and the right luminance/chrominance signal is eliminated.

16. The parallel axis stereoscopic camera of claim 14, wherein the vergence controller calculates the binocular disparity with respect to a middle object located in the middle among the objects.

17. The parallel axis stereoscopic camera of claim 15, wherein the vergence controller calculates the binocular disparity with respect to a middle object located in the middle among the objects.

18. The parallel axis stereoscopic camera of claim 2, wherein the left image sensor and the right image sensor are mounted spaced apart from each other on a printed circuit board, and at least one of the vergence controller, the image processor, the stereoscopic image synthesizer, the stereoscopic RGB data synthesizer, and the stereoscopic image processor is mounted on the printed circuit board between the left image sensor and the right image sensor.

19. The parallel axis stereoscopic camera of claim 3, wherein the left image sensor and the right image sensor are mounted spaced apart from each other on a printed circuit board, and at least one of the vergence controller, the image processor, the stereoscopic image synthesizer, the stereoscopic RGB data synthesizer, and the stereoscopic image processor is mounted on the printed circuit board between the left image sensor and the right image sensor.

20. The parallel axis stereoscopic camera of claim 2, wherein the left image sensor and the right image sensor are mounted spaced apart from each other on a wafer, and at least one of the vergence controller, the image processor, the stereoscopic image synthesizer, the stereoscopic RGB data synthesizer, and the stereoscopic image processor is mounted on the wafer between the left image sensor and the right image sensor.

21. The parallel axis stereoscopic camera of claim 3, wherein the left image sensor and the right image sensor are mounted spaced apart from each other on a wafer, and at least one of the vergence controller, the image processor, the stereoscopic image synthesizer, the stereoscopic RGB data synthesizer, and the stereoscopic image processor is mounted on the wafer between the left image sensor and the right image sensor.
